(19) United States
(12) Patent Application Publication
(10) Pub. No.: US 2014/0200127 A1
(43) Pub. Date: Jul. 17, 2014

(54) System for Producing Packaging Cushioning

(71) Applicant: SEALED AIR COROORTATION (US), Elmwood Park, NJ (US)

(72) Inventors: Atul Arora, Piscataway, NJ (US); Thomas P. Orsini, Sterling, MA (US); Kostadin I. Kostadinov, Billerica, MA (US)

(73) Assignee: SEALED AIR CORPORATION (US), Elmwood Park, NJ (US)

(21) Appl. No.: 13/739,596

(22) Filed: Jan. 11, 2013

(51) Int. Cl. B31F 1/00

(52) U.S. Cl. CPC B31F 1/0003
USPC 493/407

(57) ABSTRACT

A system for producing packaging cushioning generally includes a cushion conversion machine and a supply structure for a stack of fan-folded sheet stock material. The structure is positioned relative to the machine to supply thereto the fan-folded sheet stock material for conversion thereof into packaging cushioning, and includes an inclined, load-bearing support. The load-bearing support includes a base and a riser extending upwardly from the base, the base and the riser being structured and arranged to cooperatively accommodate the stack of fan-folded sheet stock material such that the sheet stock material is supplied to the cushion conversion machine from a top of the stack and a bottom of the stack is supported by the base. The riser is inclined at an angle relative to vertical such that the stack of fan-folded sheet stock material is also inclined at the angle, whereby, the stack is urged against the riser by force of gravity.

### BACKGROUND OF THE INVENTION

The present invention relates generally to packaging cushioning and, more specifically, to a system for producing packaging cushioning from fan-folded sheet stock material, such as paper.

Machines for producing packaging cushioning from sheet stock material are well-known in the art. Such machines generally operate by pulling a web of paper from a roll, manipulating the paper web in such a way as to convert the paper into packaging cushioning, and then severing the cushioning into cut sections of a desired length. While such machines are widely used and have been commercially successful, certain drawbacks exist. For example, paper rolls tend to be quite heavy and cumbersome to lift and load onto cushion conversion machines. Further, the shape of paper rolls limits the amount of paper supply that can be stored on a machine and shipped in a delivery truck. Moreover, because of the inertial aspects of a rotating roll, coupled with a reduction in the diameter thereof as the roll is depleted, relatively sophisticated web handling devices are needed in order to control the tension in the paper web and prevent tearing thereof.

An alternative to the use of paper in roll form is paper or other type of stock material that has been ‘fan-folded’ and formed into a stack. A fan-folded stack of sheet stock material is a web thereof, which generally has a series of alternating, transverse folds that form a sequence of superimposed sheets joined together by the folds, which allows the web to assume a resting position in the form of a stack, with the joined, superimposed sheets compressed against one another by force of gravity. The web is generally fed into the cushion conversion machine from the top of the stack, whereby the top-most sheet on the stack pulls subsequent sheets in series from the stack via the folds that join the sheets together.

One means for employing fan-folded sheet stock material is to supply the material to the conversion machine from a box. However, in order to fulfill the goal of making the sheet stock material supply relatively light and easy to handle (in comparison with paper rolls), the amount of material contained in each box must generally be limited such that frequent replacement of depleted boxes is required for continuous or semi-continuous use of the machine.

Another approach is to stack individual bundles of fan-folded material on top of one another to form a relatively large stack, with the bottom-most sheet of one bundle being joined, e.g., via two-sided adhesive tape or the like, to the top-most sheet of an adjacent bundle immediately below. In this manner, a relatively large supply of fan-folded material may be formed from several, e.g., four or five, relatively light bundles. In order to support such a stack, i.e., to ensure the stability thereof to, e.g., prevent it from toppling over, a supply structure is needed. Current structures generally have a vertical orientation, such that mechanical retention is required for at least four of the surfaces of the stack, which generally has a parallelepiped shape. Such mechanical retention generally requires that each bundle be manipulated in some fashion in order to insert it into the structure, which can make the structure difficult to load, particularly when the loader is in a stooped position. In addition, by having a vertical orientation, the full force of gravity weighs upon each bundle in the stack, which can make it hard to manipulate the bundles in the stack in order to adhesively join them together.

A further approach is to use a single, relatively large stack of fan-folded material, wherein such stack is loaded into the machine by use of a device such as a dolly, fork-lift, or the like. Ease of loading-access to the supply structure for the machine would be highly beneficial towards facilitating the loading process of large and unwieldy stacks of fan-folded material.

Accordingly, there is a need in the art for a system for producing packaging cushioning that more easily allows the loading and use of fan-folded stacks of sheet stock material.

### SUMMARY OF THE INVENTION

That need is met by the present invention, which, provides a system for producing packaging cushioning, comprising:

A. a cushion conversion machine; and

B. a supply structure for a stack of fan-folded sheet stock material, the structure being positioned relative to the machine to supply thereto the fan-folded sheet stock material for conversion thereof into packaging cushioning, the supply structure comprising an inclined, load-bearing support comprising a base and a riser extending upwardly from the base, the base and the riser being structured and arranged to cooperatively accommodate the stack of fan-folded sheet stock material such that the sheet stock material is supplied to the cushion conversion machine from a top of the stack and a bottom of the stack is supported by the base, wherein, the riser is inclined at an angle relative to vertical such that the stack of fan-folded sheet stock material is also inclined at the angle, whereby, the stack is urged against the riser by force of gravity.

Another aspect of the invention is directed towards a supply of a fan-folded sheet stock material for producing packaging cushioning in a cushion conversion machine, comprising a stack of the fan-folded sheet stock material in a supply structure, the structure being positioned relative to the machine to supply thereto the fan-folded sheet stock material for conversion thereof into packaging cushioning, the supply structure comprising an inclined, load-bearing support comprising a base and a riser extending upwardly from the base, the base and the riser being structured and arranged to cooperatively accommodate the stack of fan-folded sheet stock material such that the sheet stock material is supplied to the cushion conversion machine from a top of the stack and a bottom of the stack is supported by the base, wherein, the riser is inclined at an angle relative to vertical such that the stack of fan-folded sheet stock material is also inclined at the angle, whereby, the stack is urged against the riser by force of gravity.

A further aspect of the invention pertains to a method of loading a stack of fan-folded sheet stock material into a system for producing packaging cushioning, which includes a cushion conversion machine, the method comprising the steps of:

A. providing a supply structure for the system, the supply structure being positioned relative to the machine to supply thereto the fan-folded sheet stock material for conversion thereof into packaging cushioning, the supply structure comprising an inclined, load-bearing support comprising a base and a riser extending upwardly from the base, the base and the riser being structured and arranged to cooperatively accommodate the stack of fan-folded sheet stock material such that the sheet stock material is supplied to the cushion conversion machine from a top of the stack and a bottom of the stack is supported by the base, wherein, the riser is inclined at an angle relative to vertical; and

B. loading the stack of fan-folded sheet stock material onto the load-bearing support such that the stack of fan-folded sheet stock material is inclined at the angle relative to vertical, whereby, the stack is urged against the riser by force of gravity.

By employing fan-folded sheet stock material, e.g., paper, the system of the present invention avoids the above-described shortcomings associated with paper rolls. At the same time, by supporting the stack of fan-folded sheet stock material, e.g., paper, at an angle relative to vertical, no further mechanical retention mechanism is needed, which greatly eases the process of loading such stack into the system's supply structure, as essentially no twisting, tilting, turning or other such manipulation of the stack is needed in order to load it into the system, beyond simply setting the stack, or components thereof, onto the inclined, load-bearing support. This is in contrast to a supply structure arrangement wherein the stack is vertically oriented, which requires mechanical retention device(s) to prevent the stack from toppling over, but makes the loading process more difficult, as more complex manipulation of the stack is required. Such mechanical retention also increases the cost and complexity of the supply structure.

These and other aspects and features of the invention may be better understood with reference to the following description and accompanying drawings.

### BRIEF DESCRIPTION OF THE DRAWING

FIG. 1 is a perspective view of a system for producing packaging cushioning in accordance with the present invention, which includes a cushion conversion machine and a supply structure for a stack of fan-folded sheet stock material;

FIG. 2 is a perspective view of the system of FIG. 1, taken from the rear of the system to show the supply structure;

FIG. 3 is similar to FIG. 2, except that the stack of fan-folded sheet stock material has been removed to show the details of the supply structure;

FIG. 4 is similar to FIG. 2, wherein the fan-folded sheet stock material is prepared to be fed from the top of the stack and into the cushion conversion machine;

FIG. 5 is a side elevational view of the system as shown in FIG. 4;

FIG. 6 is similar to FIG. 5, except that a component of the supply structure (lateral support 56a) has been removed in order to show the stack in the supply structure; and

FIG. 7 is a schematic representation of the system as shown in FIGS. 5-6, in order to better show the various angles between the structural components of the system.

### DETAILED DESCRIPTION OF THE INVENTION

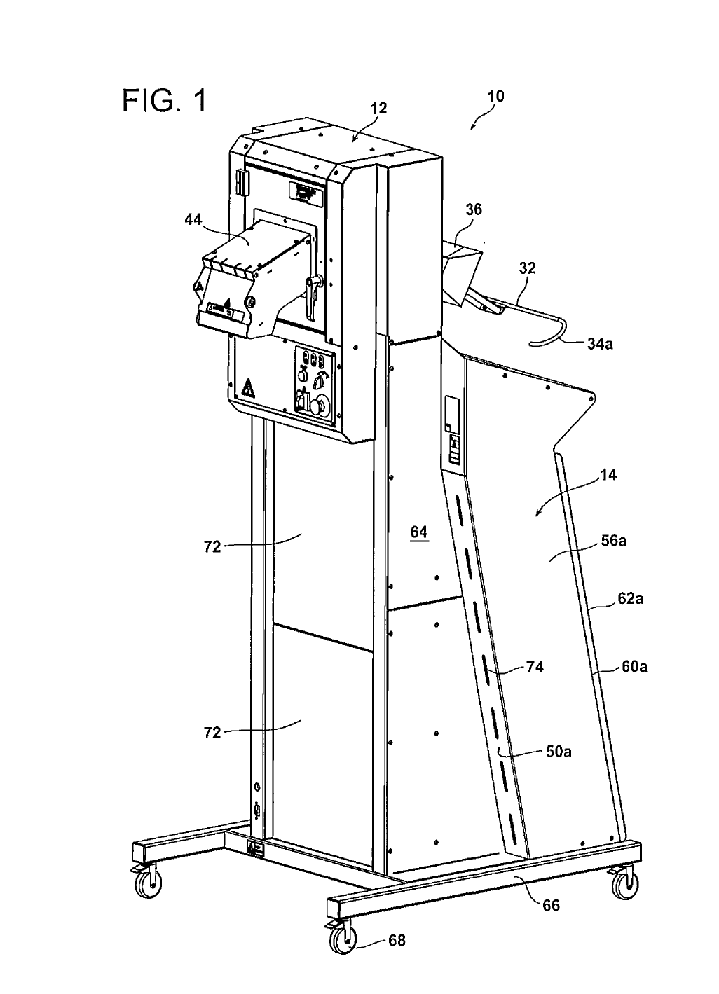

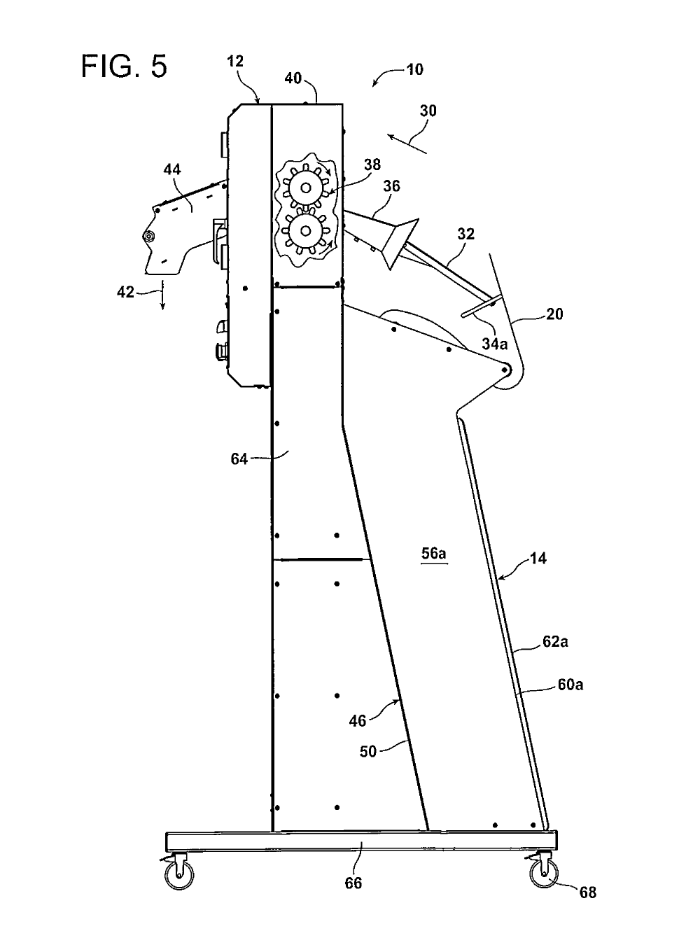

FIGS. 1-6 illustrate a system 10 for producing packaging cushioning, which generally includes a cushion conversion machine 12 and a supply structure 14 for a supply 16 of fan-folded sheet stock material 20. In the illustrated embodiment, the supply 16 is in the form of a stack, and includes five separate bundles 18, indicated as bundles 18a-18e, of fan-folded sheet stock material 20, which may be connected together, e.g., via the application of two-sided adhesive tape or the like, with the trailing end of one bundle being adhered to the leading end of an adjacent bundle (i.e., the next bundle below) in the stack 16. Thus, for instance, the trailing end (not shown) of bundle 18a may be connected to the leading end (not shown) of bundle 18b, etc. A greater or lesser number of bundles may be included in stack 16, i.e., greater than five or less than five. In addition, as an alternative to a connected stack of bundles 18, a single, relatively large bundle may comprise the stack 16.

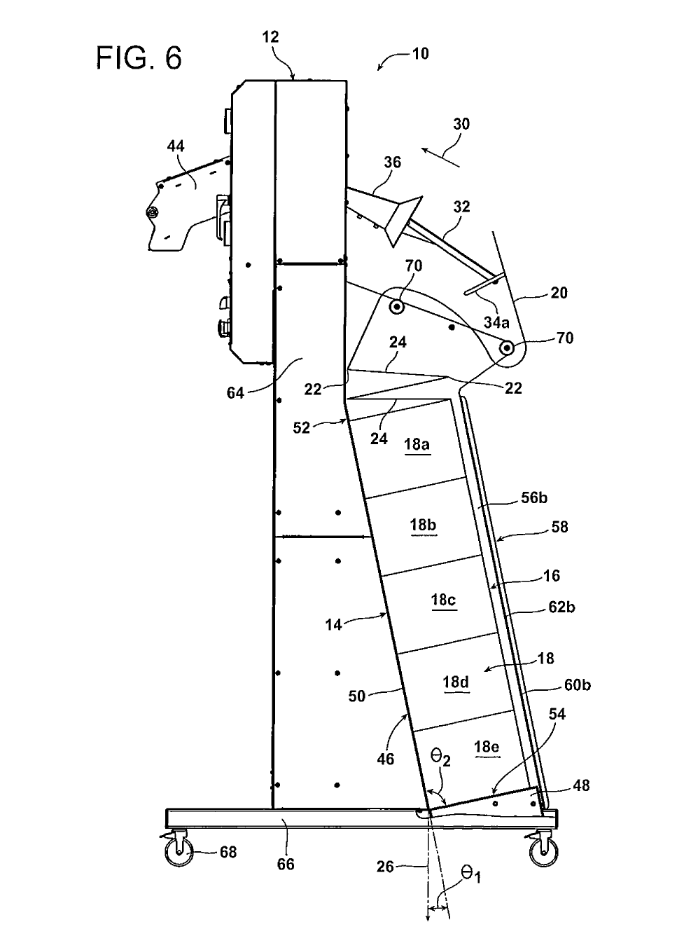

Sheet stock material 20 may comprise any type of material desired for use in packaging cushions, such as paper, e.g., kraft paper, fiberboard, thermoplastic film, etc., including recycled forms of the foregoing materials, as well as combinations thereof, e.g., laminated paper, coated paper, composite paper, etc. As shown in FIG. 6, sheet stock material 20 is in the form of a fan-folded, continuous web, with a series of alternating, transverse folds 22 that form a sequence of superimposed sheets 24 joined together by the folds 22. This allows the material 20 to be formed into parallelepiped-shaped bundles 18 as shown, which may be arranged as a stack 16 in supply structure 14, wherein the superimposed sheets 24 are compressed against one another by force of gravity, which acts in the vertical direction 26, i.e., along a ray extending radially outwards from the center of the earth.

The fan-folding of the sheet stock material 20 may be accomplished by a “folder” mechanism, e.g., as manufactured and sold by B. Bunch Co. Inc., of Phoenix, Ariz. Such a mechanism is commonly used to fan-fold items such as forms, labels, and tickets. The resultant joined sheets 24 may have any desired shape, e.g., square, rectangular, etc., with any desired dimensions, e.g., a width dimension (along the transverse direction of folds 22) ranging from 6 to 30 inches, and a depth dimension ranging from 6 to 12 inches.

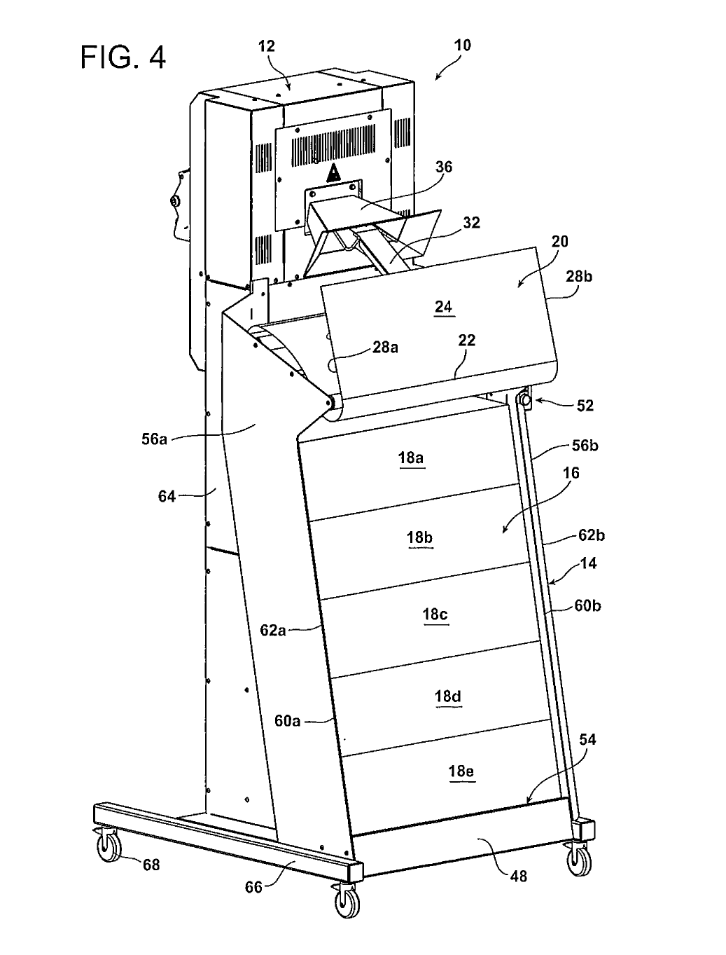

Cushion conversion machine 12 may be any conventional machine for making packaging cushioning from sheet stock material, including the PackTiger® cushioning machine, FasFil® void-fill machine, and FasFil® EZ™ void-fill machine, all of which are commercially available from Sealed Air Corporation of Elmwood Park, N.J. The machine 12 generally operates by folding and crumpling the fan-folded sheet stock material 20 to create packaging cushioning. The sheet stock material 20 is in the form of a continuous web, and is typically flat as it is withdrawn from stack 16. That is, each sheet 24 of the sheet stock web 20 has a generally planar shape, and is bounded between a pair of transverse folds 22 across the width of the web 20, and is also bounded between opposing lateral edges 28a, b of the web (FIGS. 4 and 6). The web 20 is supplied to machine 12 along a process path generally indicated by arrow 30, which may be referred to as the longitudinal (or ‘machine’) direction 30, to which the folds 22 in the web are transverse.

The machine 12 converts the web 20 from its fan-folded configuration to one in which the lateral edges 28a, b are inwardly-curled along the longitudinal direction 30, by causing the lateral edges 28a, b to converge towards one another. This is accomplished by directing the web around forming frame 32, which may comprise a pair of inwardly curved arms 34a, b, and also through forming chute 36, from which forming frame 32 extends. The spacing between inwardly-curved arms 34a, b is typically less than the width of web 20, and the width of forming chute 36 is typically less than both the width of web 20 and the spacing between arms 34a, b. In this manner, by directing the web 20 along machine direction 30, the lateral edges 28a, b of the web are forced to curl longitudinally and inwardly as the web wraps around the forming frame 32, followed by further convergence as the web travels through the more narrow forming chute 36.

Machine 12 may further include a pair of counter-rotating crumpling gears 38 located within a housing 40 of the machine, through which the web 20 travels after the lateral edges 28a, b are curled inward and converged together on forming frame 32 and in forming chute 36. The crumpling gears 38 crumple the converged web, which completes the conversion of the fan-folded sheet stock material 20 into packaging cushioning, schematically indicated at 42 as it egresses machine 12 via exit chute 44. Relative to the flat web 20, the finished cushioning material 42 has a reduced width and an increased thickness.

The crumpling gears 38 may be driven, i.e., rotationally powered by a motor or the like (not shown), to not only effect crumpling, but also to effect the movement of the web through the machine 12. The machine 12 may further include a cutting device (not shown), e.g., located within housing 40, in order to cut the cushioning material 42 into desired lengths to form individual cushioning pads. The desired length of the pads may vary depending on the intended application of the cushioning pads. For example, the cushioning pads may be used as dunnage, by positioning them between the inside surfaces of a box or other container and merchandise disposed in the container to protect the merchandise during shipping, handling, storing, and the like. Therefore, the desired length may be at least partially based on the size of the container and merchandise and/or the packaging technique (e.g., cross-cross, coil and multi-pad techniques) used to cushion and/or block and brace the merchandise in the container.

Supply structure 14 is positioned relative to machine 12 to supply thereto the fan-folded sheet stock material 20 for conversion thereof into packaging cushioning 42. Supply structure 14 comprises an inclined, load-bearing support 46, which includes a base 48 and a riser 50 extending upwardly from the base. In the illustrated embodiment, the riser 50 extends upwardly from base 48 and towards machine 12. On other embodiments, the riser 50 could extend upwardly from base 48 and away from machine 12.

Base 48 and riser 50 are structured and arranged to cooperatively accommodate the stack 16 of fan-folded sheet stock material 20 such that the sheet stock material 20 is supplied, e.g., in the form of a continuous web as described above, to cushion conversion machine 12 from the top 52 of the stack 16, wherein the sheets 24 are successively pulled from the top 52 of the stack 16 and into the machine via the folds 22 that join the sheets 24 together. The bottom 54 of the stack, including any support materials for the stack 16 and/or bottom-most bundle 18e (e.g., sleeves or boxes in which the bundles are contained), is supported by base 48. As shown, riser 50 is inclined at an angle θ₁ relative to vertical, i.e., the vertical direction 26, such that the stack of fan-folded sheet stock material 20 is also inclined at angle θ₁, whereby, the stack 16 is urged against riser 50 by force of gravity, which acts in vertical direction 26.

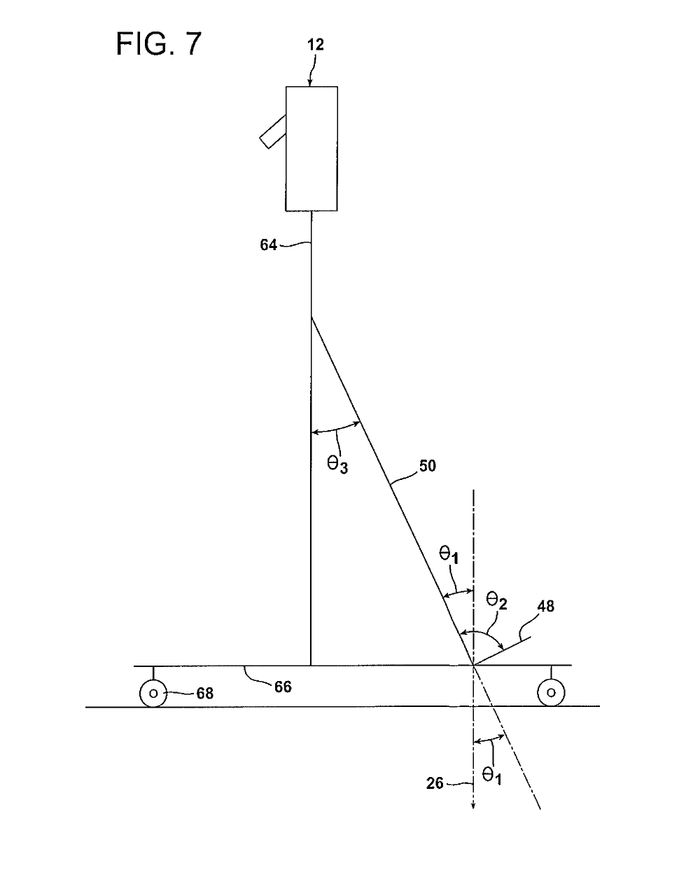

FIG. 7 is a schematic representation of some of the structural components of system 10 that are shown in FIG. 6. Given that gravity acts in the vertical direction 26 and riser 50 is inclined at angle θ₁ to vertical direction 26, one portion of the weight of stack 16 is urged against riser 50 while another portion is urged against base 48, with the relative amounts of such weight portions being dependent upon the degree of angle θ₁ from vertical 26. In the illustrated embodiment, angle θ₁ is acute. Thus, the greater the angle θ₁ relative to vertical 26, the greater will be the portion of the weight of stack 16 that is urged against riser 50, and the less of such weight portion that will be urged against base 48. Conversely, the greater the supplementary (obtuse) angle to angle θ₁, the lesser will be the portion of the weight of stack 16 that is urged against riser 50, and the more of such weight portion that will be urged against base 48. The angle between the riser 50 and vertical 26 may, in general, range from greater than 0° to less than 180°. With reference to angle θ₁ shown in FIGS. 6-7, which is acute, such angle may range from greater than 0° to less than 90°, such as greater than 5° to less than 45°, greater than 10° to less than 20°, etc. As a corollary, the supplementary angle to angle θ₁ may range from greater than 90° to less than 180°.

By supporting stack 16 at an angle, e.g., angle θ₁, relative to vertical, no further mechanical retention mechanism is needed, which greatly eases the process of loading the stack into the supply structure 14, inasmuch as the stack 16 may be loaded by simply setting the stack onto the inclined, load-bearing support 46 with substantially no further action being required. Thus, the supply structure 14 may consist essentially of the inclined, load-bearing support 46. This is in contrast to a supply structure arrangement wherein the stack is vertically oriented, which requires mechanical retention devices to prevent the stack from toppling over, but makes the loading process more difficult and increases the cost and complexity of the supply structure.

If desired, supply structure 14 may include a pair of spaced-apart lateral supports 56a, b, which may be positioned adjacent to the inclined, load-bearing support 46 (in FIG. 6, lateral support 56a has been removed in order to show stack 16 in supply structure 14). If included, the lateral supports 56a, b are spaced sufficiently apart to accommodate therebetween the stack 16 of fan-folded sheet stock material 20, and serve to provide lateral stability thereto when contained in supply structure 14. The lateral supports 56a, b may each be in the form of unitary panels, as shown, or may take the form of one or more discrete rods, bars, slats, etc. Further, the lateral supports 56a, b may be supported independently of load-bearing support 46, or may be integral therewith, e.g., attached thereto as shown.

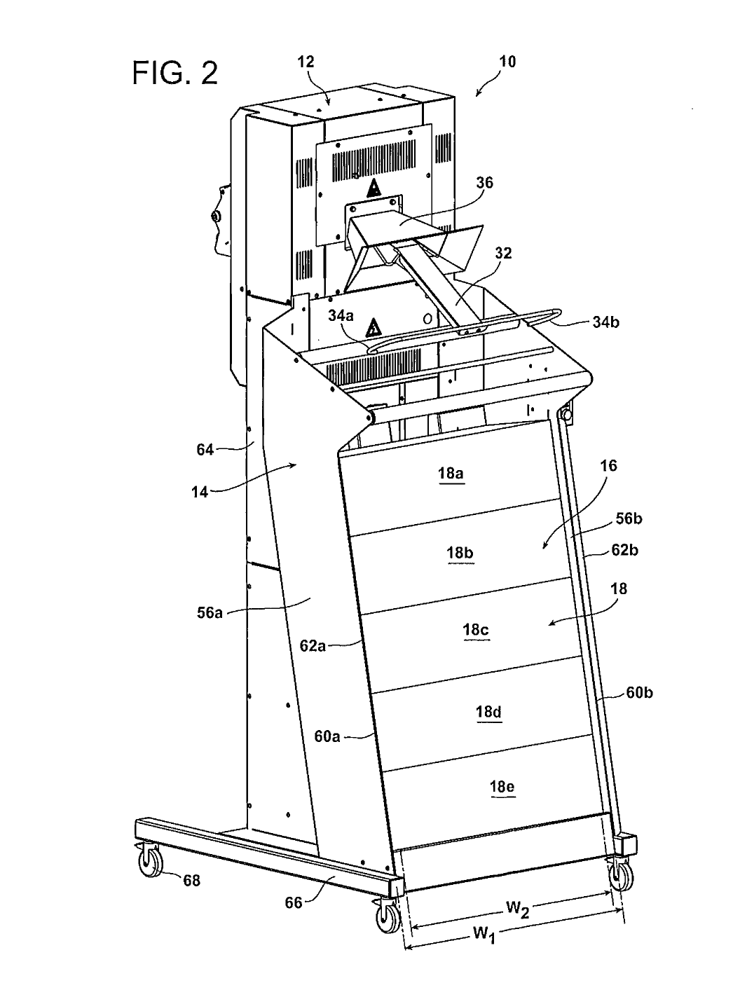

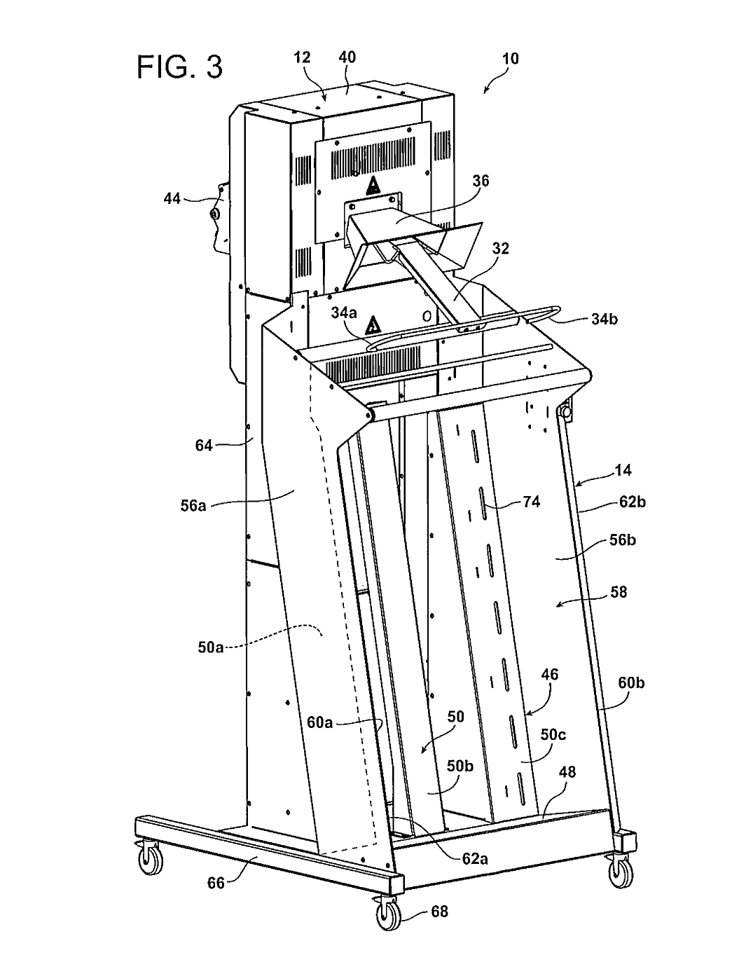

In those embodiments in which lateral supports 56a, b are included, the supply structure 14 may consist essentially of load-bearing support 46 and the lateral supports 56a, b. As perhaps best shown in FIG. 3, the load-bearing support 46 and lateral supports 56a, b may define three sides of the resultant supply structure 14, with an opening 58 being defined between opposing distal edges 60a, b of respective lateral supports 56a, b. Opening 58 has a width W₁, wherein such width W₁ is at least as great as a full width W₂ of the stack 16 of fan-folded sheet stock material 20 (FIG. 2), such that the stack 16 may be loaded onto load-bearing support 46 by moving the full width W₂ of the stack 16 through the opening 58 without the need to further manipulate the stack, e.g., such that substantially no tilting, angling, rotating, etc. of the bundles 18 is required. Thus, for those embodiments in which lateral supports 56a, b are included in supply structure 14, loading of the stack 16, e.g., via bundles 18, into the structure 14 is much easier relative to a vertically oriented structure, inasmuch as the stack need only be set and/or slid into place in structure 14.

Loading may be further facilitated by including no mechanical retention devices in opening 58 for stack 16. Such retention devices are not needed due to the inclined, load-bearing support structure 46 in accordance herewith, wherein the angle θ₁ of riser 50 relative to vertical 26 ensures that some of the weight of the stack 16 is borne by riser 50 and some is borne by base 48, which provides a stable support for the stack. When utilized, lateral supports 56a, b provide protection from incidental lateral contact with the stack, e.g., by a person or moving object, and/or to protect the stack from strong air movements, which can occur in certain use environments. If desired, opening 58 may include a pair of outwardly-flared guide brackets 62a, b, which may extend from respective distal edges 60a, b as shown, in order to further facilitate the loading of bundles 18 into the supply structure 14.

Riser 50 may comprise a single component or two or more separate components. In the illustrated embodiment, riser 50 includes three separate components, indicated as riser components 50a-c in FIG. 3. As may be appreciated, a single unitary structure, e.g., extending across the width W₁ of supply structure 14 (FIG. 2), could, instead, be employed for riser 50.

With reference to FIGS. 6 and 7, it may be seen that base 48 is oriented at an angle θ₂ relative to riser 50, wherein angle θ₂ ranges from greater than 0° to less than 180°, such as greater than 30° to less than 150°; greater than 60° to less than 120°; or greater than 80° to less than 100°. When angle θ₂ is approximately 90° as shown, bundles 18a-e are aligned in stack 16 on the inclined, load-bearing support 46 as shown in FIG. 6, i.e., such that the outer surfaces thereof (nearest opening 58) are substantially co-planar. In contrast, when angle θ₂ is obtuse, bundles 18a-e will be stacked in the inclined, load-bearing support 46 in a non-aligned manner, i.e., such that the outer surfaces thereof (nearest opening 58) are off-set from one another in separate planes in a ‘stair-step’ manner. Either type of stack configuration may be employed in accordance with the present invention.

System 10 may further include an upright stand 64 to which cushion conversion machine 12 is mounted. Upright stand 64 may be aligned in a substantially vertical orientation, i.e., in alignment with vertical direction 26, as perhaps best shown in FIGS. 6-7. The riser 50 of inclined, load-bearing support 46 may thus be oriented at an angle relative to upright stand 64, which may range from greater than 0° to less than 180°. In FIG. 7, the acute form of such angle is identified as angle θ₃, which may range from greater than 0° to less than 90°, such as greater than 5° to less than 45°, greater than 10° to less than 20°, etc. As a corollary, the supplementary angle to angle θ₃ may range from greater than 90° to less than 180°. As may be appreciated, for those embodiments wherein upright stand 64 is aligned with the vertical direction 26 (as illustrated), angle θ₃ will be substantially the same as angle θ₁.

Upright stand 64 and supply structure 14 may be independent from one another or, as illustrated, may be attached together, e.g., in the form of a substantially integrated apparatus as shown, which may be mounted on a platform 66 with wheels 68 to allow the system 10 to be moved as desired.

With reference to FIG. 6, it may be seen that supply structure 14 may include one or more guide rollers 70 to direct the sheet-stock material 20 from the stack 16 and into machine 12 via forming frame 32 and forming chute 36.

System 10 may further include a visual indicator relative to an amount, i.e., height, of stack 16 of fan-folded sheet stock material 20 contained in supply structure 14. Such an indicator may be useful to an operator of system 10, who generally works facing the exit chute 44, so that he/she may know when the supply of fan-folded sheet stock material 20 in supply structure 14 is nearing exhaustion and will have to be replenished with a new stack 16 of bundles 18. With reference to FIG. 1, it may be seen that upright stand 64 may include one or more, e.g., a pair, as illustrated, of front panels 72. A visual indicator as to the amount of sheet stock supply 20 in structure 14 may be effected by constructing the panels 72 from a transparent material, such as polycarbonate or the like. Alternatively or in addition, such visual indicator may be provided by including a series of indicator slots 74 in riser components 50a and/or 50c (FIGS. 1 and 3), which may extend along a portion of, or, as illustrated, substantially the entire length of, such riser components, and thereby permit a view of the supply of bundles 18 therebehind in supply structure 14.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention.

What is claimed is:

1. A system for producing packaging cushioning, comprising:
A. a cushion conversion machine; and
B. a supply structure for a stack of fan-folded sheet stock material, said structure being positioned relative to said machine to supply thereto the fan-folded sheet stock material for conversion thereof into packaging cushioning, said supply structure comprising an inclined, load-bearing support comprising a base and a riser extending upwardly from said base, said base and said riser being structured and arranged to cooperatively accommodate the stack of fan-folded sheet stock material such that the sheet stock material is supplied to said cushion conversion machine from a top of the stack and a bottom of the stack is supported by said base, wherein, said riser is inclined at an angle relative to vertical such that the stack of fan-folded sheet stock material is also inclined at said angle, whereby, the stack is urged against said riser by force of gravity.

2. The system of claim 1, wherein said supply structure further includes a pair of spaced-apart lateral supports positioned adjacent to said inclined, load-bearing support and spaced sufficiently to accommodate therebetween the stack of fan-folded sheet stock material.

3. The system of claim 2, wherein said supply structure consists essentially of said load-bearing support and said lateral supports.

4. The system of claim 2, wherein said load-bearing support and said lateral supports define three sides of said supply structure, with an opening being defined between opposing distal edges of said lateral supports, said opening having a width, said width being at least as great as a full width of the stack of fan-folded sheet stock material such that the stack may be loaded onto said load-bearing support by moving said full width of the stack through said opening without the need to further manipulate the stack.

5. The system of claim 4, wherein said opening includes no mechanical retention device for the stack.

6. The system of claim 1, further including an upright stand to which said machine is mounted.

7. The system of claim 6, wherein said stand is aligned in a substantially vertical orientation.

8. The system of claim 6, wherein said stand and said supply structure are attached together.

9. The system of claim 6, wherein said stand and said supply structure form a substantially integrated apparatus.

10. The system of claim 6, wherein said riser is oriented at an angle relative to said stand, said angle ranging from greater than 0° to less than 180°.

11. The system of claim 1, wherein said riser extends upwardly from said base and towards said machine.

12. The system of claim 1, wherein said angle ranges from greater than 0° to less than 180°.

13. The system of claim 1, wherein said base is oriented at an angle relative to said riser, said angle ranging from greater than 0° to less than 180°.

14. The system of claim 1, wherein said supply structure consists essentially of said inclined, load-bearing support.

15. The system of claim 1, wherein said supply structure further includes one or more guide rollers to direct the sheet-stock material from the stack and into said machine.

16. The system of claim 1, further including a visual indicator relative to an amount of said stack of flan-folded sheet stock material.

17. A supply of a fan-folded sheet stock material for producing packaging cushioning in a cushion conversion machine, comprising a stack of said fan-folded sheet stock material in a supply structure, said structure being positioned relative to said machine to supply thereto the fan-folded sheet stock material for conversion thereof into packaging cushioning, said supply structure comprising an inclined, load-bearing support comprising a base and a riser extending upwardly from said base, said base and said riser being structured and arranged to cooperatively accommodate the stack of fan-folded sheet stock material such that the sheet stock material is supplied to said cushion conversion machine from a top of the stack and a bottom of the stack is supported by said base, wherein, said riser is inclined at an angle relative to vertical such that said stack of fan-folded sheet stock material is also inclined at said angle, whereby, the stack is urged against said riser by force of gravity.

18. A method of loading a stack of fan-folded sheet stock material into a system for producing packaging cushioning, which includes a cushion conversion machine, said method comprising the steps of:
A. providing a supply structure for said system, said supply structure being positioned relative to said machine to supply thereto the fan-folded sheet stock material for conversion thereof into packaging cushioning, said supply structure comprising an inclined, load-bearing support comprising a base and a riser extending upwardly from said base, said base and said riser being structured and arranged to cooperatively accommodate the stack of fan-folded sheet stock material such that the sheet stock material is supplied to said cushion conversion machine from a top of the stack and a bottom of the stack is supported by said base, wherein, said riser is inclined at an angle relative to vertical; and
B. loading the stack of fan-folded sheet stock material onto said load-bearing support such that said stack of fan-folded sheet stock material is inclined at said angle relative to vertical, whereby, the stack is urged against said riser by force of gravity.

19. The method of claim 18, wherein:
said supply structure further includes a pair of spaced-apart lateral supports positioned adjacent to said inclined, load-bearing support and spaced sufficiently to accommodate therebetween the stack of fan-folded sheet stock material;
said load-bearing support and said lateral supports define three sides of said supply structure, with an opening being defined between opposing distal edges of said lateral supports, said opening having a width, said width being at least as great as a full width of the stack of fan-folded sheet stock material such that the stack may be loaded onto said load-bearing support by moving said full width of the stack through said opening without the need to further manipulate the stack; and
said loading step includes moving said full width of the stack through said opening without the need to further manipulate the stack.
